(19) United States
(12) Patent Application Publication
(10) Pub. No.: US 2003/0059506 A1
(43) Pub. Date: Mar. 27, 2003

(54) Pathogen control on agricultural commodities

(76) Inventor: Lynn Johnson, Falls, ID (US)

Correspondence Address: Michael F. Krieger, Kirton & McConkie, 60 East South Temple, 1800 Eagle Gate Tower, Salt Lake City, UT, 84111, US

(21) Appl. No.: 10/243,558

(22) Filed: Sep. 13, 2002

Related U.S. Application Data
(60) Provisional application No. 60/323,900, filed on Sep. 21, 2001.

(51) Int. Cl. A23C 1/00

(52) U.S. Cl. 426/320

(57) ABSTRACT

The present invention provides systems and methods that expose high concentrations of a pathogen eliminating gas, such as ozone (O₃) gas, to an agricultural commodity. A covered gas chamber, having an entrance location, an exit location, and a conveyor system therebetween, is used to receive an agricultural commodity and to expose the commodity to high concentrations of the ozone gas within the chamber. The gas is supplied to the chamber by one or more ozone generators that are coupled to one or more inlet ports of the chamber. The ozone concentration within the chamber is measured and selectively controlled. The entrance and exit locations include brushes that provide an ozone barrier at each location. The agricultural commodity is received by the conveyor system, enters the chamber, is exposed to the high concentrations of ozone gas, and exits the chamber. The exposed commodity is then delivered to a storage bay, where ozone off gas from the ozone barrier of the gas chamber is delivered.

### RELATED APPLICATIONS

This application claims priority to provisional application serial No. 60/323,900, filed Sep. 21, 2001.

### BACKGROUND OF THE INVENTION

1. Field of the Invention

The present invention relates to providing pathogen control on agricultural commodities. In particular, the present invention relates to systems and methods that utilize high concentrations of a pathogen eliminating gas on agricultural commodities.

2. Background and Related Art

Agricultural commodities such as meat and produce are subject to various pathogens that can cause spoilage or present a danger to humans if consumed. One such pathogen that causes spoilage is commonly referred to as “pink rot” and is caused by the soil-borne fungus Phytophthora erythroseptica. Rotted tuber tissues that turn pink after exposure to the air characterize pink rot. Agricultural commodities affected by pink rot include potatoes and onions. Pink rot has a tendency to spread from, for example, potato to potato, and an entire crop in storage can be destroyed in a matter of days or weeks. Another such pathogen that causes spoilage is commonly referred to as “soft rot,” which affects such commodities as potatoes and broccoli. Symptoms of soft rot include rotted tissues that are wet and soft. The rotted tissue is usually odorless in the early stages, but a foul odor develops as secondary organisms invade the infected tissue.

Agricultural commodities are also subject to various pathogens that can endanger human health if present during consumption. Examples of naturally occurring pathogens that endanger human health include the various kinds of E. coli, which are food borne pathogens that cause serious threats to human health when the pathogen carriers are inadequately treated. By way of example, the various kinds of E. coli may cause such infections in humans as meningitis, septicaemia, urinary tract infections, and intestinal infections.

Similarly, some pathogens, such as the spore-forming bacterium Bacillus anthracis (anthrax), may be purposely introduced to agricultural products by terrorist groups. The intestinal disease form of anthrax follows the consumption of contaminated agricultural products. Intestinal anthrax is characterized by acute inflammation of the intestinal tract, which results in nausea, loss of appetite, vomiting, fever, abdominal pain, vomiting of blood, and severe diarrhea. Intestinal anthrax results in death in 25% to 60% of cases.

One attempt to prevent the agricultural loss and/or human danger caused by such pathogens is to control the pathogens by applying a chemical treatment. One such chemical that has been used to treat agricultural products is chlorine. While chlorine has proven to be effective in reducing pathogens, the chlorine leaves harmful carcinogens that are unsuitable for most food product treatment purposes.

Another attempt to prevent the agricultural loss and/or human danger is to control the pathogens by treating the agricultural commodities with low concentrations of ozone gas (O₃). While this attempt has shown to be somewhat effective to control harmful pathogens at low concentrations of ozone, the ozone is difficult to contact with the desired pathogens because it is very reactive with a very short half-life. Furthermore, it is difficult to get the low concentrations of ozone in contact with a particular pathogen before the pathogen reacts with and affects other biological substances.

### SUMMARY OF THE INVENTION

The present invention relates to providing pathogen control on agricultural commodities. More particular, the present invention relates to systems and methods that utilize high concentrations of a pathogen eliminating gas on agricultural commodities.

Implementation of the present invention takes place in association with high concentrations of ozone (O₃) gas. The ozone gas is a powerful oxidant that breaks down into oxygen (O₂) and carbon dioxide (CO₂) gases in the oxidation process and does not leave harmful residuals. Ozone is very reactive and extremely fast acting, 2000 to 3000 times as fast as chlorine. Ozone has a very short half life and therefore does not linger in the treatment area. It is difficult to keep other oxidants, such as chlorine, in contact with the target pathogen to get satisfactory deactivation. Because of the extremely fast action of ozone, the contact time is reduced so the treatment can keep up with the harvest. Ozone's fast reaction makes it difficult to get ozone in contact with the pathogen before it combines with another material in the oxidizing process. As such, one implementation of the present invention relates to subjecting an agricultural commodity, such as potatoes, to high concentrations of ozone for a relatively short time insuring ozone will reach the pathogen. The high ozone concentrations ensure that the ozone reaches all of the pathogens on the potatoes and that the necessary amount of ozone is available for deactivation to occur.

In one implementation, an enclosed ozone gas chamber is used. The chamber includes a conveyor system that receives the potatoes to be treated, and moves the potatoes into, through and out of the ozone filled chamber. The conveyor system is of a sufficient length to provide the required treatment time of the potatoes to the ozone. In order to contain high concentrations of ozone gas, the conveyor is covered and has ozone barriers at each end to keep the ozone in the chamber. The ozone concentration level in the chamber is measured and controlled in order that the potatoes passing through the chamber are treated to desired concentrations of ozone in order to control the pathogens. The ozone is prevented from leaving the chamber through the use of ozone barriers that keep the ozone concentration outside of the chamber at a safe level.

The chamber comprises a conveyor that includes a belt made of a material that withstands the high concentrations of ozone applied to the potatoes. A cover is attached to provide a seal between the conveyor and the cover and is located on the conveyor so that the belt is sealed. Ozone is delivered to the tunnel from one or more ozone generators through tubes that are coupled to a distribution pipe located inside the top of the cover to deliver ozone gas throughout the length of the tunnel. The ozone barriers on each end include brushes spaced far enough apart to provide the barrier between the brushes.

A slightly negative air pressure is provided to the ozone barrier so that any ozone that moves from the chamber into the ozone barrier will be removed by a vacuum hose connected to the ozone barrier to provide the negative pressure. The vacuum hose delivers the ozone off gas to a process that destroys the ozone away from any personnel. Optionally, the off gas may be delivered to a plenum and then to a potato pile in a storage bay, where the off gas is used to disinfect stored potatoes. Alternatively, the off gas may be delivered to another gas chamber.

In one embodiment of the present invention, a blower attached to an exhaust stack is mounted to the exit area of the ozone barrier to ensure that any excess ozone is removed from the product and carried away from any people that may be present. A sensor capable of detecting ozone levels may be situated away from the conveyor system. When the sensor detects the presence of ozone beyond an acceptable level of concentration, the sensor activates a blower control, which in turn activates the blower. The blower operates until the external ozone concentration reaches an acceptable level.

While the methods and processes of the present invention have proven to be particularly useful in the area of providing pathogen control on potatoes, those skilled in the art can appreciate that the methods and processes can be used to provide pathogen control on a variety of different kinds of agricultural commodities.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for exposing high concentrations of a pathogen eliminating gas on agricultural commodities;

FIG. 2 is a cross-sectional view of the gas chamber provided in the representative system of FIG. 1;

FIG. 3 is a flow chart that illustrates a representative embodiment for a method that continuously exposes high concentrations of the eliminating gas on an agricultural commodity;

FIG. 4 provides an illustration of a storage bay used to continue treatment of the agricultural commodity by exposing the stored commodity to off gas from the gas chamber illustrated in FIG. 1; and

FIG. 5 is a cross-sectional view of an alternate embodiment of the gas chamber of FIG. 2, which includes a sensor and blower device to ensure that the external ozone concentration remains within an acceptable range.

### DETAILED DESCRIPTION OF THE INVENTION

The present invention relates to providing pathogen control on agricultural commodities. More particular, the present invention relates to systems and methods that utilize high concentrations of a pathogen eliminating gas on agricultural commodities.

In the disclosure and in the claims, the term “agricultural commodity” shall refer to a product that may be obtained by cultivating land, by raising crops, or by feeding, breeding, and raising animals, and is susceptible to a pathogen. Furthermore, in the disclosure and in the claims, the term “high concentration” in reference to a pathogen eliminating gas shall refer to concentrations of the gas in excess of 1500 parts per million in a gas chamber when the conveyor inside the gas chamber is stopped, and when the conveyor is moving the levels of ozone concentration vary from at least 100 parts per million at the entrance and exit locations of the gas chamber to a much higher concentration at the center of the gas chamber, and, depending on the speed of the conveyor, the higher concentration approaches 1500 parts per million.

Embodiments of the present invention relate to applying high concentrations of a pathogen eliminating gas, such as ozone (O₃) gas, for pathogen control on agricultural commodities. In particular, embodiments of the present invention embrace the use of a gas chamber that includes a conveyer of sufficient length to provide the required treatment time of the gas to the agricultural commodity while on the moving conveyor.

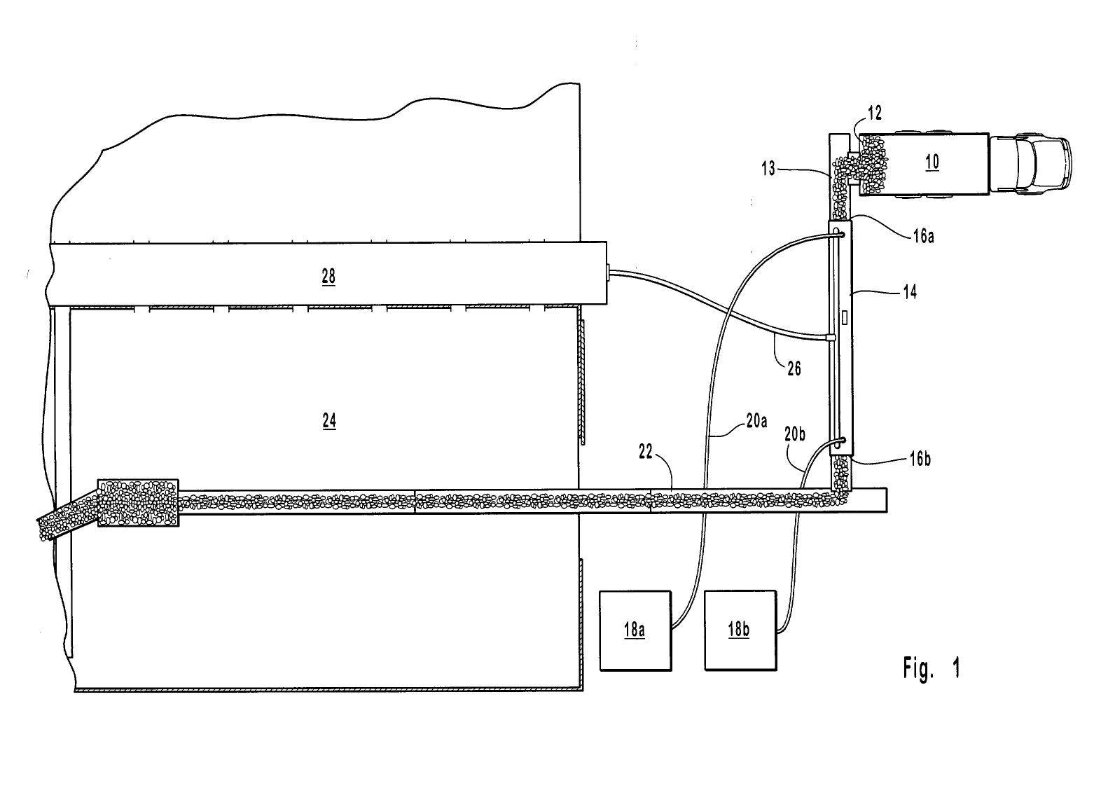

With reference to FIG. 1, a representative system is illustrated that provides a suitable operating environment for exposing high concentrations of a pathogen eliminating gas to an agricultural commodity. In FIG. 1, a supply of an agricultural commodity, illustrated as truck 10 unloading potatoes 12, is provided to a receiving portion of a conveyor system, which includes conveyor 13. In the illustrated embodiment, conveyor 13 extends through a gas chamber 14, which includes an entrance location 16a and an exit location 16b for the agricultural commodity and corresponding conveyor system. Therefore, the potatoes 12 that are loaded onto conveyor 13 are moved into, through, and out of gas chamber 14 by conveyor 13, which is an example of means for moving an agricultural commodity through a gas chamber.

Gas chamber 14 exposes potatoes 12 to a pathogen eliminating gas. In one embodiment, the pathogen eliminating gas is ozone (O₃) gas that is supplied by one or more ozone generators 18 coupled to the gas chamber 14 by one or more corresponding delivery hoses 20. The ozone generators 18 supply enough ozone gas to maintain a high concentration of ozone gas inside of gas chamber 14. The high concentration of ozone gas ensures that the ozone reaches all pathogens on the potatoes 12, and that the necessary deactivation for control of the pathogens occurs. Moreover, the length of gas chamber 14, and the corresponding conveyor system, is long enough to provide proper exposure time to the potatoes while inside gas chamber 14.

Once the exposed potatoes exit the gas chamber 14 at location 16b, they are optionally loaded onto conveyor 22 and delivered to another handling system, illustrated as storage bay 24. In one embodiment, a potato piler is utilized in delivering the potatoes within storage bay 24. In the illustrated embodiment, vacuum hose 26 connects gas chamber 14 to plenum 28. Hose 26 receives ozone off gas from gas chamber 14 and delivers the off gas to plenum 28, which in turn delivers the off gas to the storage bay 24 through a variety of air tubes (not shown) after the air tubes have been covered with potatoes. The delivery of the ozone off gas disinfects the potatoes stored in storage bay 24.

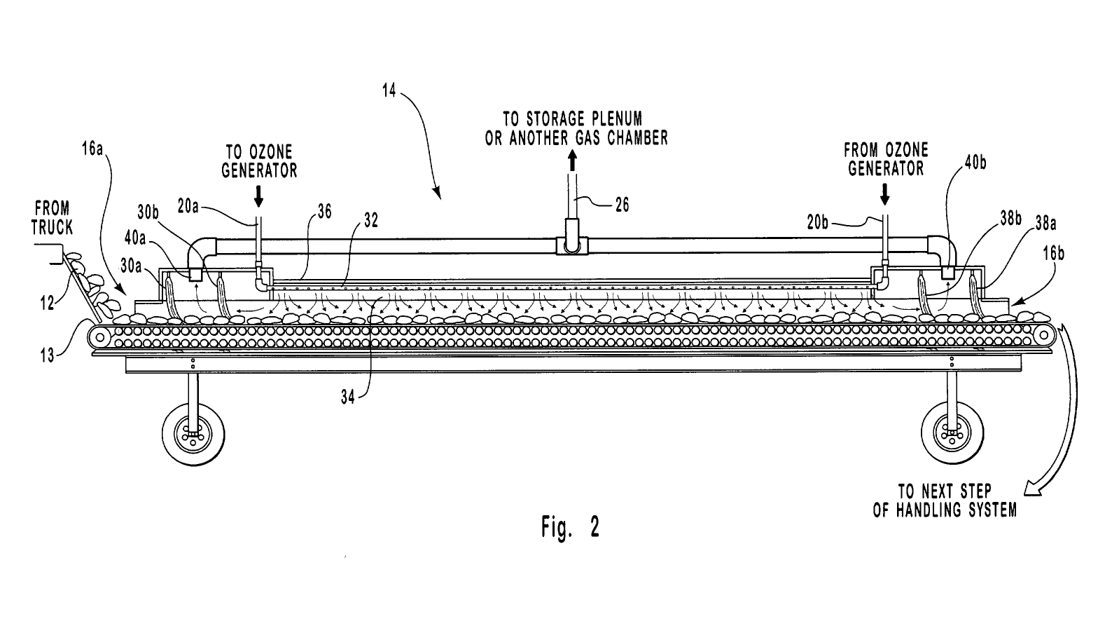

With reference now to FIG. 2, a cross-sectional view of gas chamber 14 is provided. In the illustrated embodiment, gas chamber 14 includes a conveyor 13 having a belt that comprises a material that will withstand the high concentrations of ozone experienced in the gas chamber 14. A canopy 36 is attached to provide a seal between the conveyor and the canopy 36, and to provide a channel 34 through which the potatoes 12 may pass while being exposed to a high concentration of ozone gas. While in the illustrated embodiment the canopy is located on the conveyor so that the belt forms a seal thereon, the canopy does not contact the belt close to the conveyor ends because of the conveyor construction and in order to maintain a seal.

During operation, agricultural commodities, such as potatoes 12 or other food products, are placed on the conveyor 13 and are treated at a desired ozone concentration while traveling through the channel 34. The ozone concentration and/or the time in which the agricultural commodity is in gas chamber 14 may be varied as necessary to obtain a desired deactivation of a pathogen. For example, a regulator may selectively adjust the speed of the conveyor system to modify the time in which the agricultural commodity on the conveyor is exposed to the high concentration of ozone in the gas chamber, and wherein the regulator is an example of means for controlling the speed. The ozone concentration may be varied by the amount of ozone delivered to the chamber. The canopy 34 may be applied to existing conveyors in order to perform the gas treatment without excessive modifications to existing systems.

As provided above, the ozone gas is provided to the gas chamber 14 by one or more ozone generators, which deliver the ozone gas through delivery hoses 20, which are coupled to a distribution pipe 32 that extends down channel 34. Distribution pipe 32 is mounted inside the top of canopy 36 and includes a plurality of gas outlets that are spaced so that the ozone gas is delivered throughout the length of the channel 34, where the potatoes are exposed to the ozone gas.

In the illustrated embodiment, entrance and exit brushes 30 and 38 are employed to provide an ozone barrier at the entrance and exit locations, respectively. The barriers, as well as the canopy 36, maintain the ozone gas within the chamber 14. Maintaining the ozone within the chamber not only preserves the ozone, but also keeps the ozone concentration at a high concentration in the chamber and at a safe level so that workers located near the chamber 14 are not exposed to dangerous amounts of the ozone gas.

The entrance and exit brushes 30 and 38 may comprise, for example, a polymer material, such as polypropylene or another polymer material. Furthermore, the entrance and exit brushes 30 and 38 are thick, flexible and long enough to follow the surface of the potato or other commodity moving through gas chamber 14 in order to effectively restrict or stop air movement past the brushes. Moreover, each of the pair of entrance brushes 30a and 30b and exit brushes 38a and 38b are spaced far enough apart to provide the ozone barrier between each entrance brush 30a and 30b and between each exit brush 38a and 38b.

A slightly negative air pressure is provided in each ozone barrier so that any air movement is going into the barrier. In one embodiment, a vacuum at each of the ozone barriers is provided by a small blower (not shown). Furthermore, to provide the negative air pressure, vacuum pipes 40 are connected to each barrier and then to a vacuum hose 26, which delivers ozone off gas from gas chamber 14 to means for destroying the ozone before it is discharged into the surrounding atmosphere. Alternatively, the ozone off gas may be delivered from the vacuum pipes 40 to plenum, such as plenum 28 of FIG. 1, as will be further explained below.

In another embodiment, the ozone off gas is delivered from the vacuum pipes 40 to one or more other gas chambers (not shown). The other gas chambers may be connected in series or in parallel with gas chamber 14. When in series, the passing of the agricultural commodity from one gas chamber to another gas chamber allows the position of the agricultural commodity to change so that all of the surfaces of the commodity are exposed to a high concentration of ozone gas. Therefore, by way of example, if a first potato and a second potato are in contact with each other and with the conveyor belt while passing through a first gas chamber, the passing of the potatoes from the first gas chamber to another gas chamber causes the first and second potatoes to rotate or otherwise change position so that the surfaces of the first potato that were in contact with the belt or with the second potato while passing through the first gas chamber are exposed to the high concentration of ozone in the second gas chamber. Likewise, the surfaces of the second potato that were in contact with the belt or with the first potato while passing through the first gas chamber are exposed to the high concentration of ozone in the second gas chamber. Alternatively, the use of gas chambers in parallel allow for the ozone gas to be reused and for an increased volume of agricultural commodities to be exposed the ozone gas. Embodiments of the present invention further embrace the use of means for measuring and/or controlling the ozone concentration level so that when the potatoes or other commodities are placed on the conveyor 13, the potatoes are treated to the desired concentration of ozone gas while moving or traveling through the channel 34. In one embodiment, means for measuring and/or controlling the ozone concentration level includes an ozone monitor that continuously monitors the ozone concentration and that selectively shuts off or initiates the ozone generators as necessary. Sample ports may be included in gas chamber 14 to allow a representative sample of ozone to be taken and measured. The ozone monitor is an example of means for monitoring the high concentration of the ozone gas.

In the illustrated embodiment, the agricultural commodity is recently harvested and has not undergone a transformative process. The agricultural commodity enters the gas chamber 14 at an entrance location 16a, travels through the channel 34, and is delivered or otherwise provided at exit location 16b. The path of travel for the agricultural commodity from the entrance location 16a to the exit location 16b is linear. Furthermore, while the exterior of the gas chamber is subject to the surrounding environmental conditions, such as wind, rain, etc., the high concentration of ozone gas is not diluted by the environmental conditional, but rather is maintained within the gas chamber through the use of the ozone barriers at the entrance location 16a and at the exit location 16b, which allow for the agricultural commodity to pass therethrough, but prevent the escape of ozone gas.

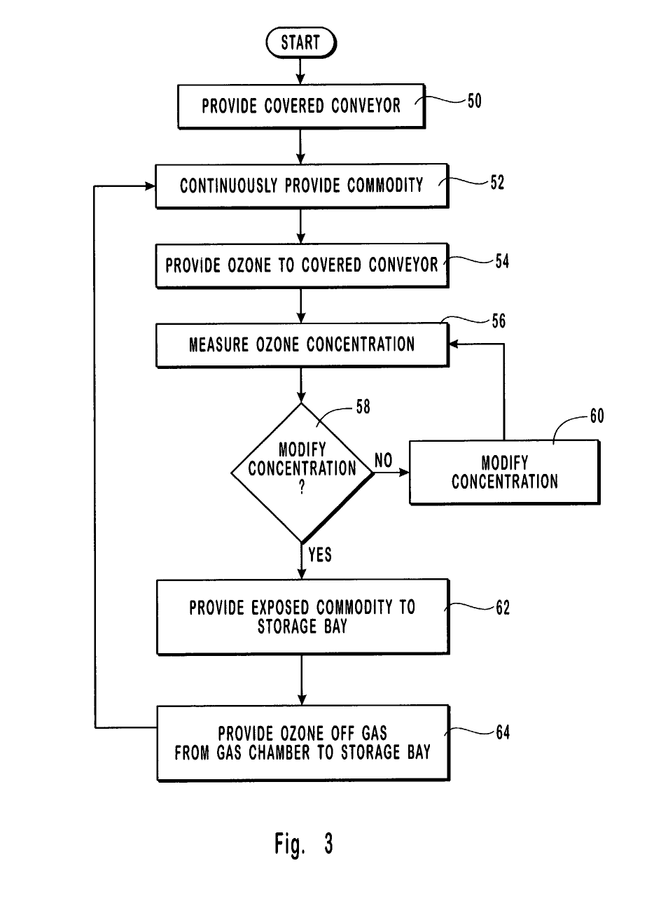

Thus, with reference now to FIG. 3, a flow chart is provided that illustrates a representative embodiment for a method that continuously exposes an agricultural commodity to high concentrations of a pathogen eliminating gas. In FIG. 3, execution begins at a first step 50, where a covered conveyor is provided in order to pass an agricultural commodity therethrough and to expose the commodity to a high concentration of a pathogen eliminating gas, such as ozone gas, within the covered conveyor. Execution then proceeds to a second step 52, which continuously provides the agricultural commodity to the covered conveyor.

At a third step 54, the ozone gas is provided to the covered conveyor in order to expose the agricultural commodity to the ozone. At a fourth step 56, a measurement is made to determine the ozone concentration located within the covered conveyor. As provided above, the measurement may be made through the use of an ozone monitor. Execution then proceeds to decision block 58 for determination as to whether or not to modify the concentration of the gas. A modification may be made when, for example, the concentration is too weak or too strong. Therefore, if it is determined at decision block 58 that the concentration is to be modified, execution proceeds to a fifth step 60 for the modification of the ozone concentration and then back to the fourth step 56 to measure the ozone concentration. Alternatively, if it is determined at decision block 58 that the concentration of the ozone within the covered conveyor is not to be modified, execution proceeds to a sixth step 62, where the exposed agricultural commodity is continuously provided to a storage bay. At a seventh step 64, the ozone off gas is provided from the covered conveyor to the storage bay where the exposed agricultural commodity is located.

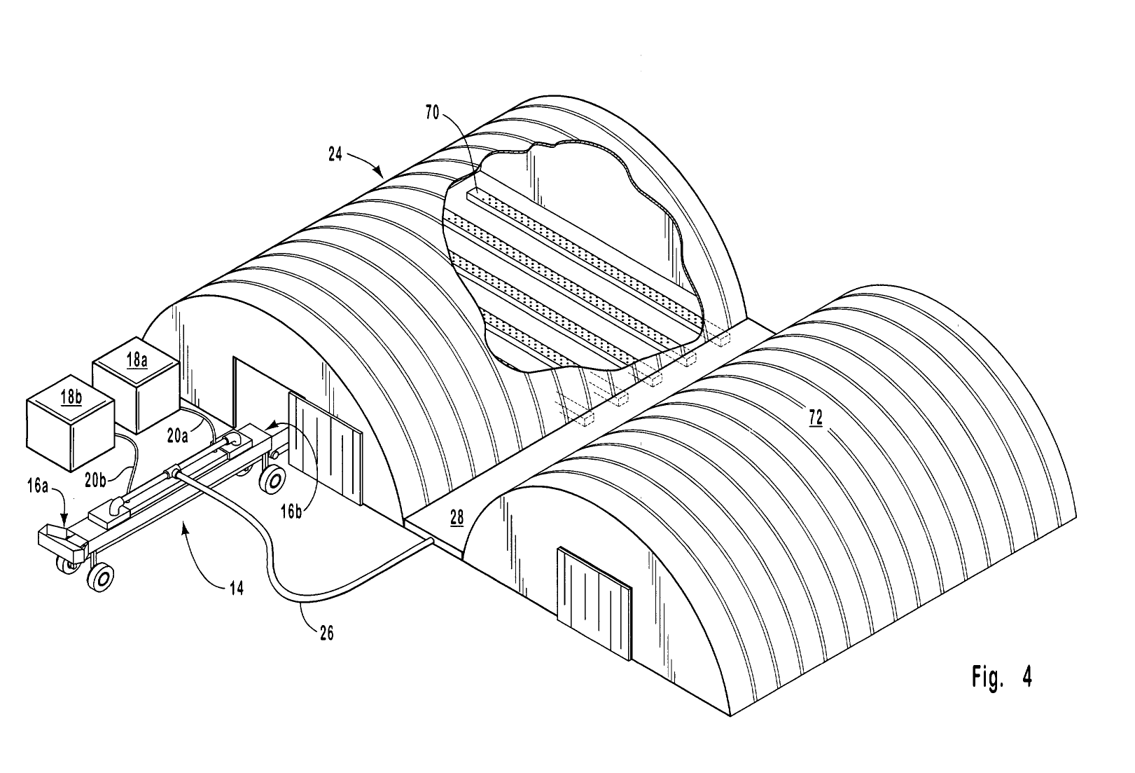

With reference now to FIG. 4, an illustration is provided of a storage bay that may be used to continue treatment of the agricultural commodity by exposing the stored commodity to ozone off gas taken from a gas chamber. In FIG. 4, gas chamber 14 is illustrated that includes a high concentration of ozone therein supplied from ozone generators 18 through delivery hoses 20. As explained above, gas chamber 14 includes an entrance location 16a for the agricultural commodity (e.g., potatoes or other products) and an exit location 16b. Once exposed, the potatoes are transported into a storage bay 24. In one embodiment, the potatoes are transported through the use of a conveyor and a potato piler.

In one embodiment, the storage bay 24 includes a plurality of air vent pipes 70. Vacuum pipes 40 (FIG. 2) are coupled to the ozone barriers on each end of the gas chamber 14 and then to a vacuum hose 26, which delivers ozone off gas to a plenum 28. The plenum 28 is coupled to one or more storage bays 24 and 72 of the ventilation system of the potato storage. (Alternatively, the vacuum hose 26 may be coupled to means to destroy the ozone before it is discharged into the surrounding atmosphere.) A small blower (not shown) provides the vacuum used to deliver the ozone off gas.

The potatoes, which have been exposed to the high concentrations of ozone gas in the gas chamber 14, are piled by a potato piler on or about the air vent pipes 70 within a storage bay 24. All of the openings of the air vent pipes 70 that do not have potatoes piled on them are closed, forcing the ozone off gas into the potato pile where the off gas is used to disinfect the stored potatoes.

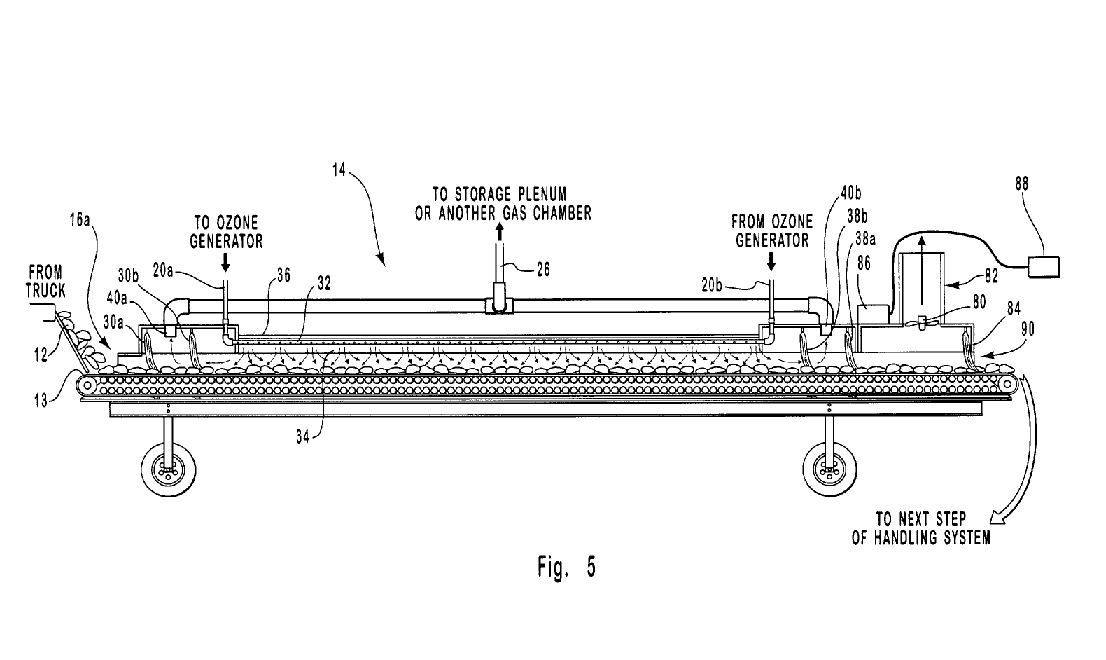

With reference now to FIG. 5, an alternate embodiment of the gas chamber 14 of FIG. 2 includes a blower 80 mounted to an extended exit area 90 of the ozone barrier. A final exit brush 84 restricts airflow into the area beneath the blower 80, thus facilitating the blower's 80 function in removing excess ozone from the agricultural product. An exhaust stack 82 coupled to the blower 80 directs such excess ozone away from any people that may be present. To further ensure that the blower 80 functions effectively to limit exposure to harmful levels of ozone, a sensor 88 capable of detecting ozone levels may be situated in the external environment, away from the conveyor system. When the sensor 88 detects ozone in the external environment beyond an acceptable level of concentration, the sensor 88 activates a blower control 86 coupled to the blower 80, which in turn activates the blower 80. The blower 80 operates until the external ozone concentration reaches an acceptable level.

While the methods and processes of the present invention are particularly useful in the area of providing pathogen control in potatoes, those skilled in the art can appreciate that the methods and processes can be used to provide pathogen control on a variety of different kinds of agricultural commodities. Moreover, those skilled in the art can also appreciate that the system configurations illustrated in FIGS. 1, 2, 4 and 5 are representative only, and that the embodiments of the present invention embrace a variety of similar system configurations used to expose high concentrations of a pathogen eliminating gas to an agricultural commodity.

Thus, as discussed herein, the embodiments of the present invention embrace systems and methods that utilize high concentrations of a pathogen eliminating gas, such as ozone (O₃), on agricultural commodities. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a system for providing pathogen control on an agricultural commodity, a method for using high concentrations of ozone gas to provide the pathogen control, the method comprising:
generating an ozone gas;
applying a high concentration of the ozone gas to a gas chamber having an entrance location and an exit location; and
continuously providing the agricultural commodity to the gas chamber at the entrance location to provide pathogen control by exposing the agricultural commodity to the high concentration of the ozone gas as the agricultural commodity linearly passes through the gas chamber from the entrance location to the exit location.

2. A method as recited in claim 1, wherein the agricultural commodity comprises a potato.

3. A method as recited in claim 1, wherein the step for applying includes the step for measuring the concentration of the ozone gas in the gas chamber.

4. A method as recited in claim 3, wherein the step for applying further includes selectively modifying the concentration of the ozone gas in the gas chamber.

5. A method as recited in claim 1, wherein the step for continuously providing the agricultural commodity includes using a conveyor to pass the agricultural commodity through the gas chamber.

6. A method as recited in claim 1, further comprising the steps for:
delivering the exposed agricultural commodity from the gas chamber to a storage bay; and
delivering an ozone off gas from the gas chamber to the storage bay, wherein the off gas is exposed to the agricultural commodity in the storage bay.

7. A method as recited in claim 6, further comprising the step for minimizing concentrations of excess ozone off gas present outside of said gas chamber.

8. A system for providing pathogen control on an agricultural commodity, the system comprising:
a gas chamber configured to receive an agricultural commodity;
an ozone gas source coupled to the gas chamber at a gas inlet port to provide a high concentration of ozone gas within the chamber; and
means for moving the agricultural commodity through the gas chamber for exposure to the high concentration of ozone gas, wherein the means are coupled to the gas chamber.

9. A system as recited in claim 8, wherein the high concentration of ozone gas within the chamber is within the range of 100 to 500 parts per million.

10. A system as recited in claim 8, wherein the high concentration of ozone gas within the chamber is within the range of 500 to 1000 parts per million.

11. A system as recited in claim 8, wherein the high concentration of ozone gas within the chamber is within the range of 1000 to 1500 parts per million.

12. A system as recited in claim 8, wherein the high concentration of ozone gas within the chamber exceeds 1500 parts per million.

13. A system as recited in claim 8, wherein the agricultural commodity comprises a potato.

14. A system as recited in claim 8, wherein the gas chamber comprises:
an entrance location and an exit location;
a conveyor system that moves the agricultural commodity from the entrance location to the exit location of the gas chamber;
a first ozone barrier located at the entrance location of the gas chamber; and
a second ozone barrier located at the exit location of the gas chamber.

15. A system as recited in claim 14, further comprising one or more brushes used to form the first ozone barrier, and one or more brushes used to form the second ozone barrier.

16. A system as recited in claim 14, further comprising:
an extended exit area located beyond the exit location;
a third ozone barrier located at the extended exit area;
a blower coupled to aid extended exit area; and
an exhaust stack coupled to said blower.

17. A system as recited in claim 16, wherein one or more brushes comprise the third ozone barrier.

18. A system as recited in claim 16, further comprising:
a blower control coupled to said blower;
a sensor remotely coupled to said blower control, wherein said sensor activates
said blower control upon detecting harmful concentrations of ozone gas.

19. A system as recited in claim 8, further comprising:
a storage bay for storing the exposed agricultural commodity;
a plenum coupled to the storage bay; and
a vacuum hose coupled to the gas chamber and to the plenum, wherein the vacuum hose delivers ozone off gas from the gas chamber to the plenum, and wherein the plenum is used to supply the off gas to the exposed agricultural commodity stored in the storage bay.

20. A system as recited in claim 8, wherein the gas chamber is portable.

21. A system as recited in claim 8, further comprising means for monitoring the high concentration of ozone gas in the gas chamber.

22. A system as recited in claim 8, further comprising means for controlling the speed of the means for moving the agricultural commodity through the gas chamber.

23. A system as recited in claim 8, further comprising:
a second gas chamber; and
a vacuum hose coupled to the first and second gas chambers, wherein the vacuum hose delivers ozone off gas from the first gas chamber to the second gas chamber.

24. A system for providing ozone gas to potatoes for pathogen control, the system comprising:
a gas chamber configured to receive the potatoes;
an ozone gas source coupled to the gas chamber at a gas inlet port to provide a high concentration of ozone gas within the chamber; and
a conveyor extending through the gas chamber to pass the potatoes through the gas chamber for exposure to the high concentration of ozone gas, wherein the conveyor is coupled to the gas chamber.

25. A system as recited in claim 25, wherein the high concentration of ozone gas within the chamber is within the range of 100 to 500 parts per million.

26. A system as recited in claim 25, wherein the high concentration of ozone gas within the chamber is within the range of 500 to 1000 parts per million.

27. A system as recited in claim 25, wherein the high concentration of ozone gas within the chamber is within the range of 1000 to 1500 parts per million.

28. A system as recited in claim 25, wherein the high concentration of ozone gas within the chamber exceeds 1500 parts per million.

29. A system as recited in claim 25, wherein the gas chamber comprises:
a first ozone barrier located at a first end of the gas chamber, wherein the first ozone barrier is formed by a first set of brushes, and
a second ozone barrier located at a second end of the gas chamber, wherein the second ozone barrier is formed by a second set of brushes.

30. A system as recited in claim 29, further comprising:
an extended exit area located beyond the second end of the gas chamber;
a third ozone barrier located at the extended exit area, wherein the third ozone
barrier is formed by a third set of brushes;
a blower coupled to said extended exit area;
an exhaust stack and a blower control coupled to said blower; and
a sensor remotely coupled to said blower control, wherein said sensor activates
said blower control upon detecting harmful concentrations of ozone off gas.

31. A system as recited in claim 29, wherein the first and second set of brushes comprise polypropylene.

32. A system as recited in claim 29, further comprising a vacuum hose coupled to the first and second ozone barriers and to a plenum, wherein the vacuum hose delivers ozone off gas from the ozone barriers to the plenum.

33. A system as recited in claim 32, further comprising a storage bay for storing exposed potatoes, wherein the plenum supplies the off gas to the exposed potatoes stored in the storage bay.

34. A system as recited in claim 25, further comprising an ozone monitor coupled to the gas chamber to measure the concentration of the ozone in the chamber.

35. A system for providing pathogen control on an agricultural commodity, the system comprising:
a gas chamber configured to receive the agricultural commodity at an entrance location and to deliver the agricultural commodity at an exit location, wherein a linear path of travel exists from the entrance location to the exit location;
an ozone gas source coupled to the gas chamber at a gas inlet port to provide a high concentration of ozone gas within the chamber; and
means for moving the agricultural commodity through the gas chamber on the linear path of travel from the entrance location to the exit location for exposure to the high concentration of ozone gas, wherein the means are coupled to the gas chamber.
